(19) United States
(12) Patent Application Publication
(10) Pub. No.: US 2022/0241053 A1
(43) Pub. Date: Aug. 4, 2022

(54) MAGNETIC ORTHODONTIC DEVICE

(71) Applicants: WEN-KEN TAI, TAICHUNG CITY (TW); CHANG-ER NIEN, TAICHUNG CITY (TW)

(72) Inventors: WEN-KEN TAI, TAICHUNG CITY (TW); CHANG-ER NIEN, TAICHUNG CITY (TW)

(21) Appl. No.: 17/659,351

(22) Filed: Apr. 15, 2022

Related U.S. Application Data
(63) Continuation-in-part of application No. 16/736,986, filed on Jan. 8, 2020.

(51) Int. Cl. A61C 7/00

(52) U.S. Cl. CPC A61C 7/006

(57) ABSTRACT

A magnetic orthodontic device has two correction appliances. Each of the correction appliances has a linkage portion, a first connecting portion, a second connecting portion, an adhering plate, a neodymium magnet, and a shell. The linkage portion is elongated and has two opposite ends. The first and second connecting portions are respectively disposed at the two opposite ends of the linkage portion. The adhering plate is disposed at the first connecting portion. The neodymium magnet is disposed at the second connecting portion. The adhering plate and the neodymium magnet respectively protrude toward opposite directions. The shell surrounds the neodymium magnet. The neodymium magnets of the two correction appliances are capable of repelling or attracting each other.

### CROSS-REFERENCE TO RELATED APPLICATION

This application is a continuation-in-part application of application Ser. No. 16/736,986 filed on Aug. 1, 2020, which is incorporated herein by reference.

### BACKGROUND OF THE INVENTION

### 1. Field of the Invention

The present invention relates to a device for orthodontia, and more particularly to a magnetic orthodontic device that can reduce the orthodontic treatment time and move root apexes of teeth more efficiently.

### 2. Description of Related Art

Orthodontic aligners are applied to correct malocclusion such as under bite, over bite, deep overbite, or open bite. A traditional orthodontic device has a bracket, an archwire, and an elastomeric ligature. The bracket and the archwire are metallic. The bracket is attached to teeth via adhesive, and the archwire is held to the bracket with the elastomeric ligature. The pulling interaction between the brace and the archwire guides the teeth into a desired orientation.

The traditional orthodontic device has an uneven contour. The uneven contour of the traditional orthodontic device causes food debris to easily stick to the bracket, results in difficulty in cleaning the bracket, and raises the risk of tooth decay. More particularly, the uneven contour of the traditional orthodontic device continually rubs the interior of the mouth that is the mucosa, causes a foreign body sensation in the mouth, and reduces the aesthetic appearance.

In order to overcome the above-mentioned drawbacks of the traditional orthodontic device, a clear aligner manufactured by 3D printing is invented. The clear aligner provides better wearing experience without reducing the aesthetic appeal of the patient.

However, the clear aligner still has the following defects:

1. The clear aligner is mounted on crowns of teeth. When the crowns are abutted by the clear aligner and forced to move, the force provided by the clear aligner is transmitted from the crowns to periodontal ligament, and roots of teeth slowly move consequently. Therefore, the progressive orthodontic treatment via the clear aligner takes a long period of time.

2. The orthodontic treatment via the clear aligner requires sixty to seventy sets of clear aligner for gradually correcting teeth orientation. The number of sets of clear aligner is determined according to various orthodontic treatments and treatment time. Therefore, the orthodontic treatment via the clear aligners causes high expense of producing clear aligners.

3. In order to fix the clear aligner to the teeth, an engaging member is attached to the teeth, and the clear aligner has a corresponding recess for engaging with the engaging member. However, the engaging member is made of UV curable resin and is prone to wearing out by the clear aligner and fails to engage with corresponding recess of the clear aligner. In addition, the engaging member is easily detached from the teeth and fails to fix the clear aligner when the patient has poor oral hygiene. Therefore, the clear aligner can be inadvertently detached from teeth.

To overcome the shortcomings of the clear aligner, the present invention provides a magnetic orthodontic device to mitigate or obviate the aforementioned problems.

### SUMMARY OF THE INVENTION

The main objective of the present invention is to provide a magnetic orthodontic device to shorten orthodontic treatment time by moving root apexes of teeth.

The magnetic orthodontic device comprises two correction appliances. Each of the correction appliances has a linkage portion, a first connecting portion, a second connecting portion, an adhering plate, a neodymium magnet, and a shell. The linkage portion is elongated and has two opposite ends. The first and second connecting portions are respectively disposed at the two opposite ends of the linkage portion. The adhering plate is disposed at the first connecting portion. The neodymium magnet is disposed at the second connecting portion. The adhering plate and the neodymium magnet respectively protrude toward opposite directions. The shell surrounds the neodymium magnet. The neodymium magnets of the two correction appliances are capable of repelling or attracting each other.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a magnet orthodontic device in accordance with the present invention;

FIG. 2 is a perspective view of a second embodiment of a magnet orthodontic device in accordance with the present invention;

FIG. 3 is a perspective view of a third embodiment of a magnet orthodontic device in accordance with the present invention;

FIG. 4 is a cross sectional side view of the magnet orthodontic device along line 4-4 in FIG. 3;

FIG. 5 is an operational perspective view of a first treatment using the magnet orthodontic devices in accordance with the present invention;

FIG. 6 is an operational perspective view of a second treatment using the magnet orthodontic devices in accordance with the present invention;

FIG. 7 is an operational perspective view of a third treatment using the magnet orthodontic devices in accordance with the present invention;

FIG. 8 is an operational perspective view of a fourth treatment using the magnet orthodontic devices in accordance with the present invention;

FIG. 9 is an operational perspective view of a fifth treatment using the magnet orthodontic devices in accordance with the present invention;

FIG. 10 is an operational perspective view of a sixth treatment using the magnet orthodontic devices in accordance with the present invention; and

FIG. 11 is an operational perspective view of a seventh treatment using the magnet orthodontic devices in accordance with the present invention;

FIG. 12 is a perspective view of a fourth embodiment of a correction appliance of a magnet orthodontic device in accordance with the present invention;

FIG. 13 is another perspective view of the fourth embodiment showing the correction appliance with two hooks;

FIG. 14 is a front view of the correction appliance in FIG. 13;

FIG. 15 is a lateral view of the correction appliance in FIG. 13;

FIG. 16 is an partially enlarged front view of the correction appliance in FIG. 13;

FIG. 17 is an partially enlarged cross sectional view of the correction appliance in FIG. 13;

FIG. 18 is an operational front view of the eighth treatment using the magnet orthodontic device in accordance with the present invention;

FIG. 19 is an operational lateral view of the eighth treatment using the magnet orthodontic device in accordance with the present invention; and

FIG. 20 is another operational front view of the eighth treatment using the magnet orthodontic device in accordance with the present invention.

### DETAILED DESCRIPTION OF PREFERRED EMBODIMENTS

A magnetic orthodontic device in accordance with the present invention has three embodiments. Each embodiment of the present invention has an aligner and at least one magnet mounted to the aligner.

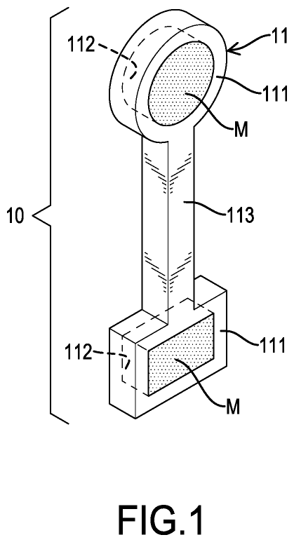

With reference to FIG. 1, a first embodiment of the present invention is a first orthodontic device 10 of a first configuration. The first orthodontic device 10 has a first aligner 11 and two magnets M. The first aligner 11 has two connecting portions 111, two assembling portions 112, and a linkage portion 113. The linkage portion 113 is elongated and has two opposite ends. The two connecting portions 111 are respectively connected to the two opposite ends of the linkage portion 113. The connecting portions 111 of the first aligner 11 are designed to increase an attachment area between the first aligner 11 and a tooth to be firmly connected to a tooth. One of the two connecting portions 111 has a circular contour. The other one of the two connecting portions 111 has a rectangular contour.

With reference to FIG. 1, the two assembling portions 112 are respectively defined in the two connecting portions 111. Each one of the two assembling portions 112 may be a recess or a through hole for receiving a respective one of the two magnets M. The two magnets M are respectively embedded in the two assembling portions 112.

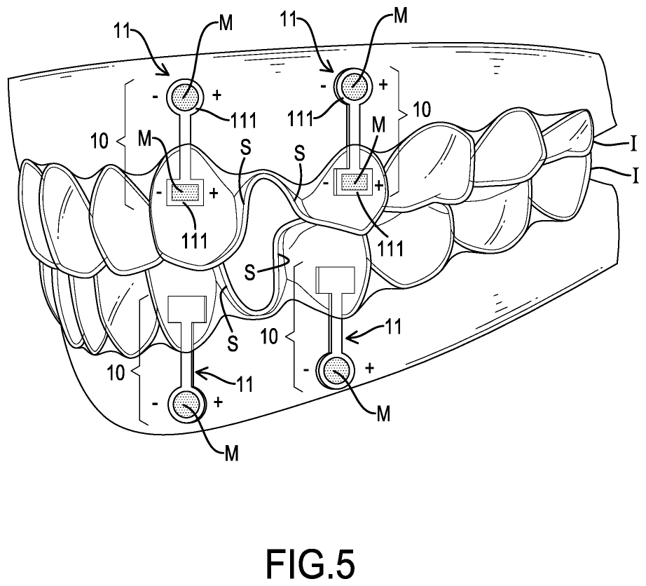

With reference to FIG. 5, in the first embodiment, the first aligner 11 has only one assembling portion 112, which is defined in one of the two connecting portions 111 of the first aligner 11. There may be only one magnet M accordingly embedded in the assembling portion 112.

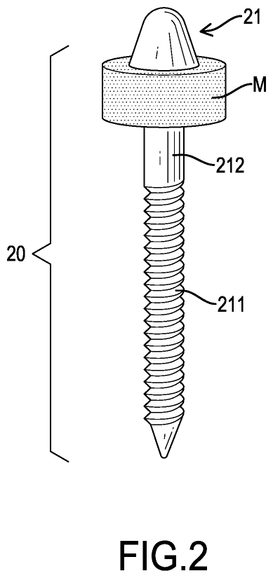

With reference to FIG. 2, a second embodiment of the present invention is a second orthodontic device 20 of a second configuration. The second orthodontic device 20 has a second aligner 21 and a magnet M. The second aligner 21 is a temporary anchorage device, TAD, and is shaped like a pole and has two opposite ends, a connecting portion 211, and an assembling portion 212. The connecting portion 211 is disposed at one of the two opposite ends of the second aligner 21 and has a thread. The assembling portion 212 is disposed adjacent to the other end of the second aligner 21. The magnet M is mounted on the assembling portion 212.

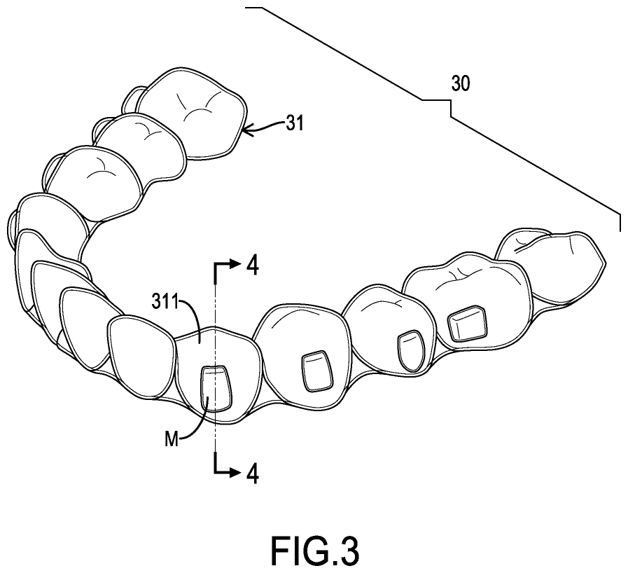

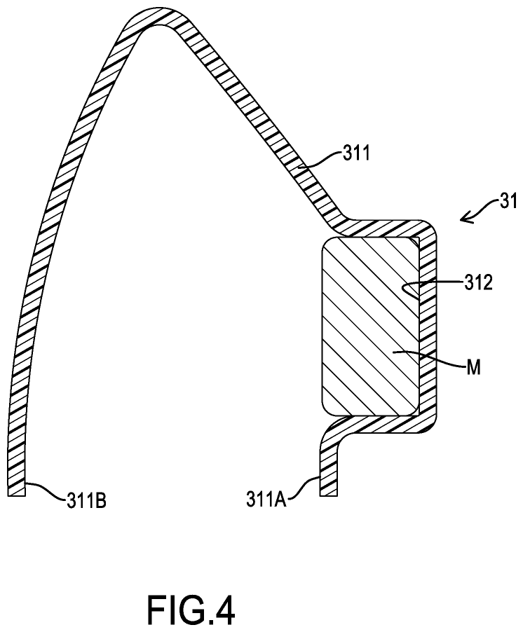

With reference to FIGS. 3 and 4, a third embodiment of the present invention is a third orthodontic device 30 of a third configuration. The third orthodontic device 30 has a third aligner 31 and multiple magnets M. The third aligner 31 is a brace with a U-shaped contour and has a connecting portion 311 and multiple assembling portions 312. The connecting portion 311 has a U-shaped cross-section and two inner peripheral surfaces 311A, 311B facing to each other. The multiple assembling portions 312 are defined in one of the two inner peripheral surfaces 311A. The multiple magnets M are respectively embedded in the multiple assembling portions 312.

With reference to FIGS. 1 and 5, a first treatment using the magnet orthodontic devices in accordance with the present invention is applied to lower teeth as illustrated in FIG. 5. In the first treatment, two said first orthodontic devices 10 are accompanied with a clear aligner I for orthodontic treatment with teeth extraction. In the first treatment, each first orthodontic device 10 has one said magnet M. The aligner 11 of each orthodontic device 10 has one said assembling portion 112 defined in a respective one of the two connecting portions 111 of the aligner 11. The magnet M of each first orthodontic device 10 is embedded in the assembling portion 112 of the aligner 11 of the first orthodontic device 10. With reference to FIG. 5, the assembling portion 112 of the aligner 11 of each first orthodontic device 10 is defined in a respective one of the aligner's connecting portions 111 that has a circular contour. The two aligners 11 of the two first orthodontic devices 10 are respectively connected to two crowns of two of the lower teeth. Each aligner 11 is connected to the crown via the rectangular connecting portion 111 of the aligner 11. The clear aligner I is connected to crowns of the lower teeth. Two gaps S are respectively formed between the clear aligner I and the corresponding two teeth respectively connected with the two aligners 11 of the two first orthodontic devices 10. The two gaps S provide enough spaces for movements of the corresponding two teeth. When the two magnets M of the two first orthodontic devices 10 attract, two roots of the corresponding two teeth approach each other. The two crowns of the corresponding two teeth are pushed by the clear aligner I and approach each other. Therefore, the corresponding two teeth slowly approach each other to accomplish orthodontic treatment with teeth extraction. The teeth orientation is corrected via both the two first orthodontic devices 10 and the clear aligner I. The crowns and roots of the teeth approach each other simultaneously. Therefore, the orthodontic treatment is accelerated.

With reference to FIGS. 1 and 5, the first treatment using the magnet orthodontic devices in accordance with the present invention can also be applied to upper teeth as shown in FIG. 5. Two first orthodontic devices 10 are respectively connected to two of the upper teeth. Each first orthodontic device 10 has two said magnets M. The aligner 11 of each first orthodontic device 10 has two assembling portions 112 respectively defined in the two connecting portions 111 of the aligner 11 of the first orthodontic device 10. The two magnets M of each first orthodontic device 10 are respectively embedded in the two assembling portions 112 of the aligner 11 of the first orthodontic device 10. The connecting portion 111 with a rectangular contour of each first orthodontic device 10 is connected to a corresponding one of the upper teeth. The upper teeth in FIG. 5 are also corrected both via the two first orthodontic devices 10 and the clear aligner I mounted on the upper teeth. Therefore, the orthodontic treatment is also speeded up.

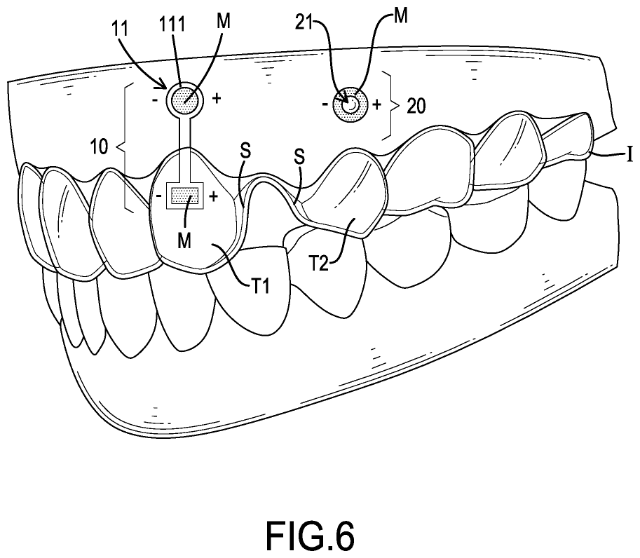

With reference to FIGS. 1, 2, and 6, a second treatment of the magnet orthodontic devices in accordance with the present invention is applied to upper teeth in FIG. 6. In the second treatment, one said first orthodontic device 10 and one said second orthodontic device 20 are accompanied with one said clear aligner I for orthodontic treatment of canines. In the second treatment, the first orthodontic device 10 has two said magnets M, and the aligner 11 of the first orthodontic device 10 has two said assembling portions 112 respectively defined in the two connecting portions 111 of the aligner 11 for receiving the two magnets M. The aligner 11 is connected to one of canines T1 of the upper teeth via one of the two connecting portions 111 having a rectangular contour. The connecting portion 211 of the second orthodontic device 20 is screwed with alveolar bone at a position near one of first molars T2 of the upper teeth. A gap S is formed between the canine T1 and the clear aligner I to provide enough space for movement of the canine T1. When the magnets M of the first orthodontic device 10 and the magnet M of the second orthodontic device 20 attract, the canine T1 moves toward the first molar T2.

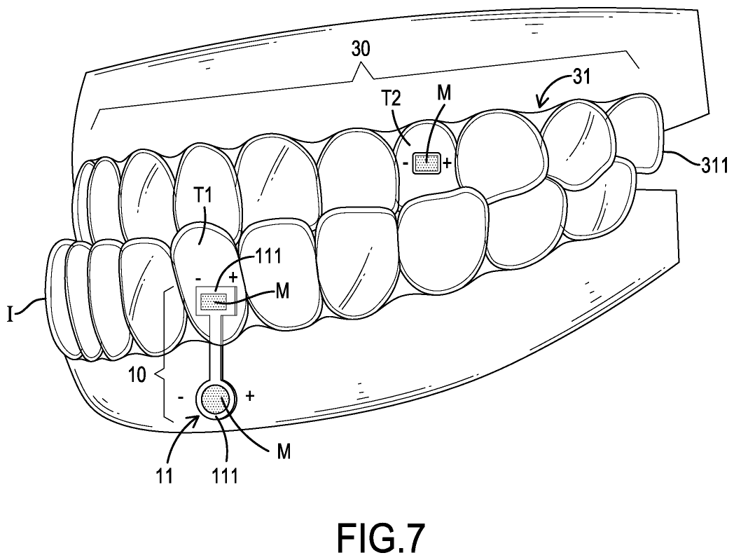

With reference to FIGS. 1, 4, and 7, a third treatment of the magnet orthodontic devices in accordance with the present invention is applied to lower teeth and upper teeth in FIG. 7. In the third treatment, one said first orthodontic device 10 and one said third orthodontic device 30 are accompanied with one said clear aligner I for orthodontic treatment of underbite. The first orthodontic device 10 and the clear aligner I are attached to the lower teeth. The first orthodontic device 10 has two said magnets M. The aligner 11 of the first orthodontic device 10 is connected to one of canines T1 of the lower teeth via one of the two connecting portions 111 with a rectangular contour. The third orthodontic device 30 is mounted on the upper teeth. The third orthodontic device 30 has a magnet M. The aligner 31 has an assembling portion 312 for receiving the magnet M. The assembling portion 312 is disposed according to a position of one of the first molars T2 of the upper teeth. When the magnet M of the first orthodontic device 10 and the magnet M of the third orthodontic device 30 attract, the first orthodontic device 10 and the third orthodontic device 30 approach each other to align the upper teeth and the lower teeth.

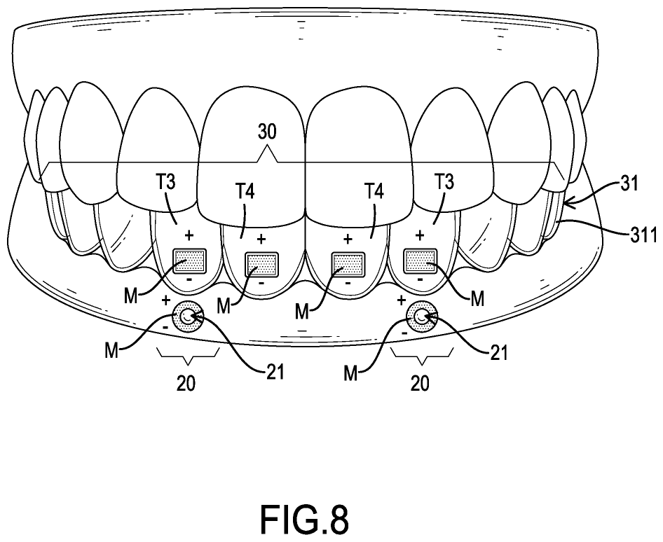

With reference to FIGS. 2, 4, and 8, a fourth treatment using the magnet orthodontic devices in accordance with the present invention is applied to lower teeth. In the fourth treatment, two said second orthodontic devices 20 are accompanied with one said third orthodontic device 30 for orthodontic treatment of deep overbite. The two connecting portions 211 of the two aligners 21 of the two second orthodontic devices 20 are screwed with the alveolar bone of mandible and respectively disposed below two lateral incisors T3 of the lower teeth. The third orthodontic device 30 is mounted on the lower teeth via the aligner 31 of the third orthodontic device 30 and has four magnets M. The aligner 31 of the third orthodontic device 30 has four assembling portions 312 for respectively receiving the four magnets M of the third orthodontic device 30. When the magnets M of the two second orthodontic devices 20 and the magnets M of the third orthodontic device 30 attract, the lower teeth move downward to move away from the upper teeth for correcting deep overbite.

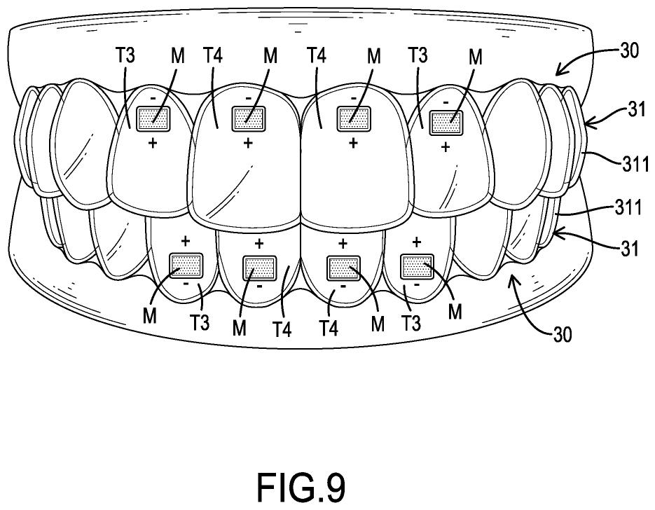

With reference to FIGS. 4 and 9, a fifth treatment of the magnet orthodontic devices in accordance with the present invention is applied to lower teeth and upper teeth in FIG. 9. Two said third orthodontic devices 30 are respectively mounted on the upper teeth and the lower teeth for orthodontic treatment of deep overbite. Each third orthodontic device 30 has four said magnets M. The aligner 31 of each third orthodontic device 30 has four said assembling portions 312. The four magnets M of each third orthodontic device 30 are respectively embedded in the four assembling portions 312 of the aligner 31 of the third orthodontic device 30. The four magnets M of the third orthodontic device 30 mounted on the upper teeth are arranged according to two central incisors T4 and two lateral incisors T3 of the upper teeth in position. The four magnets M of the third orthodontic device 30 mounted on the lower teeth are arranged according to two central incisors T4 and two lateral incisors T3 of the lower teeth in position. When the magnets M of the two third orthodontic devices 30 repel, the two third orthodontic devices 30 move away from each other. Therefore, the upper teeth and the lower teeth move away from each other.

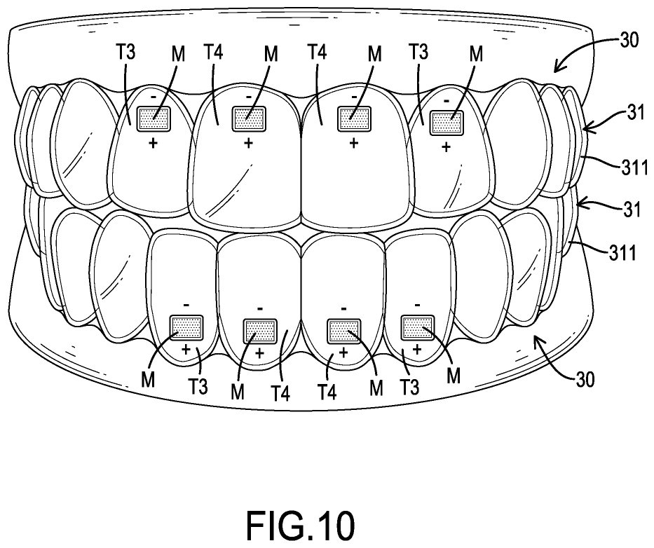

With reference to FIGS. 4 and 10, a sixth treatment using the magnet orthodontic devices in accordance with the present invention is applied to lower teeth and upper teeth. In the sixth treatment, two said third orthodontic devices 30 are respectively mounted on the lower teeth and the upper teeth for orthodontic treatment of open bite. Each third orthodontic device 30 has four magnets M. The aligner 31 of each third orthodontic device 30 has four assembling portions 312. The four magnets M of each third orthodontic device 30 are respectively embedded in the four assembling portions 312 of the aligner 31 of the third orthodontic device 30. The four magnets M of the third orthodontic device 30 mounted on the upper teeth are arranged according to two central incisors T4 and two lateral incisors T3 of the upper teeth in position. The four magnets M of the third orthodontic device 30 mounted on the lower teeth are arranged according to two central incisors T4 and two lateral incisors T3 of the lower teeth in position. When the magnets M of the two third orthodontic devices 30 attract, the two third orthodontic devices 30 approach each other. Therefore, the upper teeth and the lower teeth move toward each other.

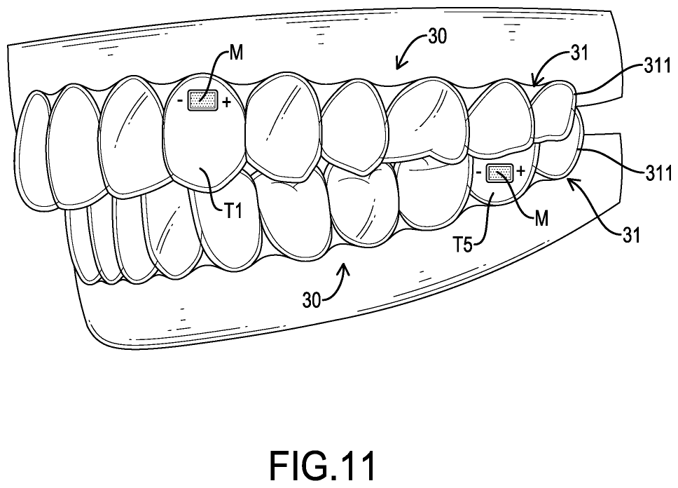

With reference to FIGS. 4 and 11, a seventh treatment using the magnet orthodontic devices in accordance with the present invention is applied to lower teeth and upper teeth. Two said third orthodontic devices 30 are respectively mounted on the upper teeth and the lower teeth. Each third orthodontic device 30 has a magnet M. The aligner 31 of each third orthodontic device 30 has one said assembling portion 312. The magnet M of each third orthodontic device 30 is embedded in the assembling portion 312 of the aligner 31 of the third orthodontic device 30. The magnet M of one of the third orthodontic devices 30 mounted on the upper teeth is arranged according to one of the canines T1 of the upper teeth in position. The magnet M of the other one of the third orthodontic devices 30 is arranged according to one of the second molars T5 of the lower teeth in position. When the magnets M of the two third orthodontic devices 30 attract, the two third orthodontic devices 30 approach each other to align the upper teeth and the lower teeth.

In the present application, FIG. 1 shows the first embodiment of the present invention. FIG. 2 shows the second embodiment of the present invention. FIG. 3 shows the third embodiment of the present invention. FIGS. 5 to 11 illustrate the first to the seventh treatments of the present invention respectively.

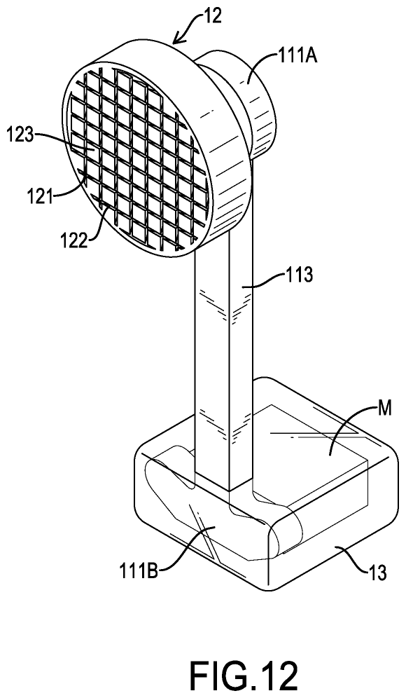

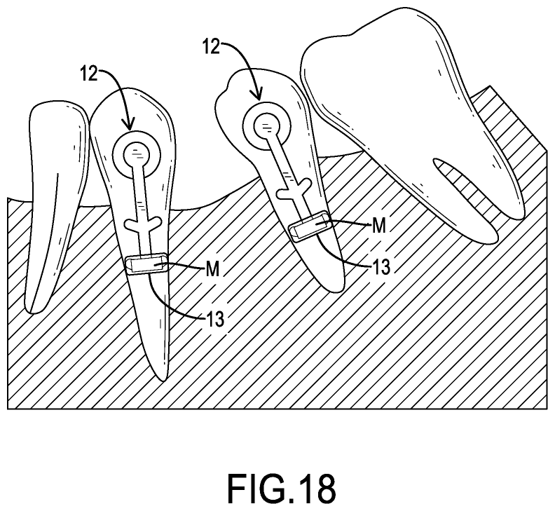

With reference to FIGS. 12 and 18, a fourth embodiment of the present invention is similar to the first embodiment of the present invention. The fourth embodiment is configured to move root apexes of teeth mesially and distally and has two correction appliances. Each of the correction appliances has the linkage portion 113 with two opposite ends and the two connecting portions 111 respectively disposed at the two opposite ends of the linkage portion 113. The two connecting portions 111 are distinguished into a first connecting portion 111A and a second connecting portion 111B. In the fourth embodiment, each of the correction appliances has a single magnet M and further has an adhering plate 12 and a shell 13.

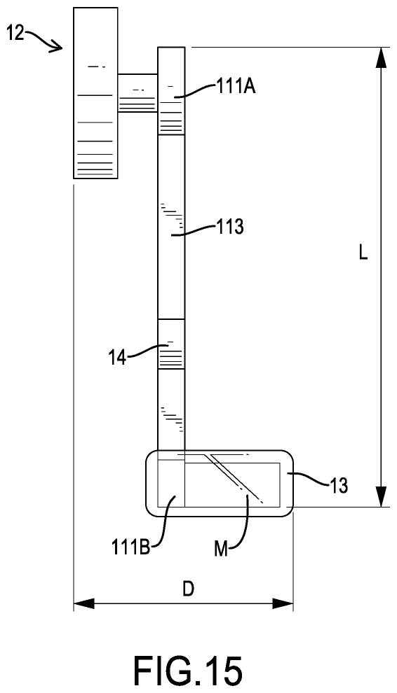

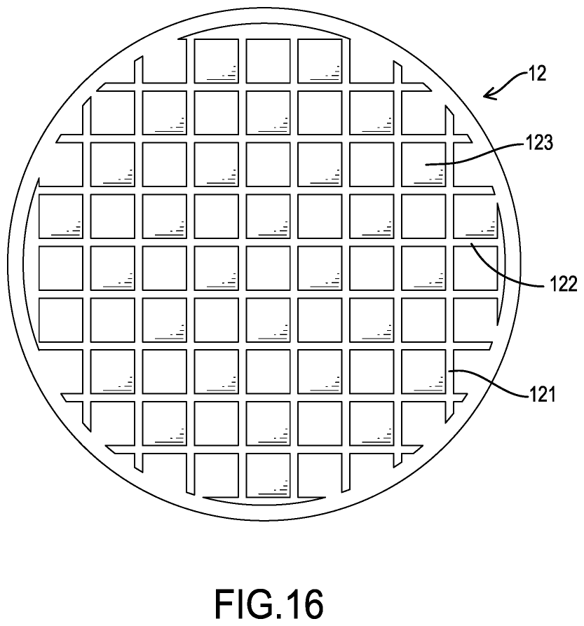

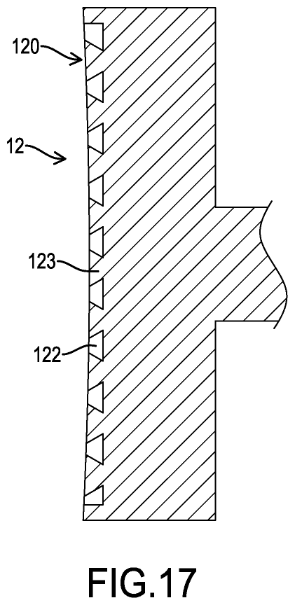

With reference to FIGS. 12 to 17, the adhering plate 12 is adapted to be connected to a tooth and is disposed at the first connecting portion 111A. The adhering plate 12 has a recession 120, multiple first grooves 121, and multiple second grooves 122. The recession 120 is concaved towards the first connecting portion 111A. Each one of the first grooves 121 and the second grooves 122 is defined in a surface of the recession 120. The multiple first grooves 121 are arranged in parallel. The multiple second grooves 122 are arranged in parallel. The multiple first grooves 121 and the multiple second grooves 122 are arranged crosswise to form multiple attaching units 123. Each one of the multiple attaching units 123 protrudes away from the first connecting portion 111A.

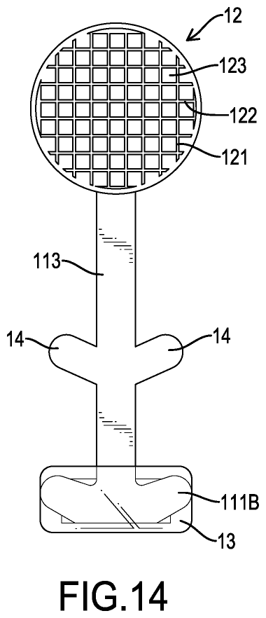

With reference to FIGS. 14, 16, and 17, in the fourth embodiment, the first grooves 121 and the second grooves 122 are arranged orthogonally. Each one of the first grooves 121 and the second grooves 122 is a dovetail groove.

With reference to FIGS. 12 to 15, the magnet M is a neodymium magnet and is disposed at the second connecting portion 111B. The magnet M being the neodymium magnet provides strong and enough magnetic force for moving a tooth. The magnets M of the two correction appliances provide attractive or repellent force being 30 to 50 milligram-force. The forces provided by the two magnets M is sufficient to move the root apexes toward or away from each other and move the tooth apexes efficiently. The magnet M is rectangular and is convenient to label a mark for distinguish poles of the magnet M.

The shell 13 is made of resin and surrounds the magnet M. The magnet M is enclosed inside the shell 13 made of resin to be free from rusting.

With reference to FIGS. 12 to 17, the adhering plate 12 and the magnet M respectively protrude toward opposite directions. A distance D is defined perpendicular to the linkage portion 113 and between a front surface of the adhering plate 12 and a rear end surface of the shell 13. The distance D is greater than or equal to 2 mm and is less than or equal to 8 mm. The linkage portion 113 has a length L. The length L is greater than or equal to 2 mm and is less than or equal to 10 mm. When the adhering plate 12 is connected to the cervical area of the crown of the tooth, the length L keeps the correction appliance from revealing as the patient smiling. The length L is designed for aesthetic reason as well.

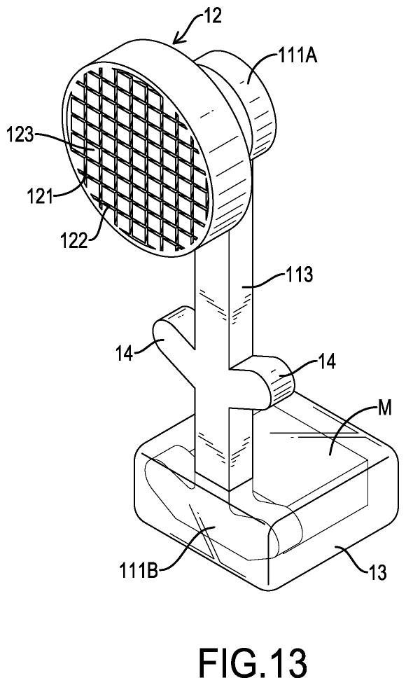

With reference to FIG. 13, each of the correction appliances further has two hooks 14. With reference to FIGS. 13 to 15, the two hooks 14 are respectively disposed at two opposite sides of the linkage portion 113. Each one of the two hooks 14 inclines toward the adhering plate 12.

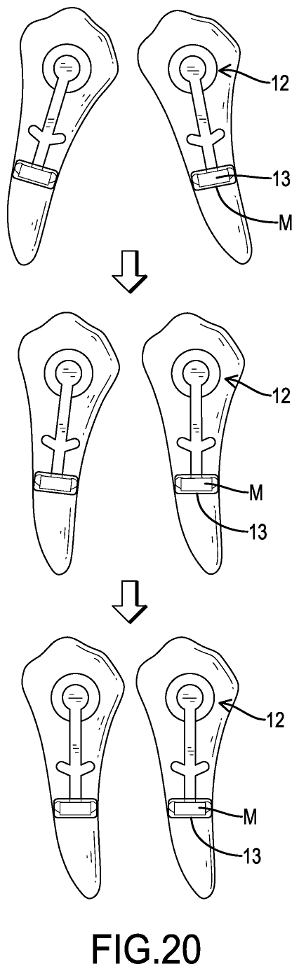

With reference to FIGS. 18 to 20, the adhering plates 12 of two correction appliances are respectively attached to two teeth. The adhering plate 12 of each one of the correction appliances is attached to one corresponding tooth via resin. Before connecting the adhering plate 12 to the said corresponding one tooth, the tooth surface of the said corresponding one tooth must be etched with 35% w/w phosphoric acid to rough the tooth surface for increasing the bonging strength between the adhering plate 12 and the tooth surface of the crown of the said corresponding one tooth. The resin is applied to the recession 120 of each one of the correction appliances, enters the first grooves 121 and the second grooves 122, and fills the recession 120.

When the correction appliance is attached to the said corresponding tooth, the resin in the first grooves 121 and the second grooves 122 engages with the attaching units 123 to make the adhering plate 12 firmly fixed to the corresponding tooth.

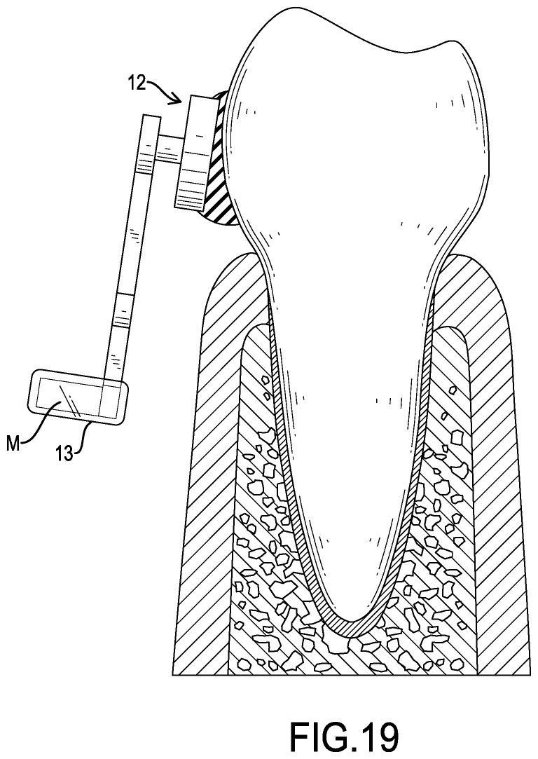

With reference to FIG. 19, the adhering plate 12 and the magnet M enclosed by the shell 13 respectively protrude toward opposite directions. When the adhering plate 12 is attached to the corresponding tooth, the magnet M and the shell 13 are away from the corresponding tooth and are free from interfering by the gingiva.

With reference to FIGS. 18 to 20, when the magnets M disposed in two pieces of the two correction appliances repel or attract each other, the crowns or the roots of the teeth swing mesially and distally. The crowns and the roots apexes of the teeth swing simultaneously, and orthodontic treatment time is shortened accordingly. Moreover, the adhering plate 12 of each correction appliances is firmly fixed to the corresponding tooth, the magnet M and the shell 13 are swingable due to magnetic forces. Therefore, the root apex of the corresponding tooth can be moved. The two root apexes of the two teeth can be gradually swung, approach each other, and move close together accordingly.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A magnetic orthodontic device being configured to move root apexes of teeth mesially and distally and comprising:
two correction appliances, and each one of the two correction appliances having
a linkage portion being elongated and having two opposite ends;
a first connecting portion and a second connecting portion respectively disposed at the two opposite ends of the linkage portion;
an adhering plate, adapted to be connected to a tooth, and disposed at the first connecting portion;
a neodymium magnet disposed at the second connecting portion;
the adhering plate and the magnet respectively protruding opposite directions; and
a shell surrounding the neodymium magnet;
wherein the neodymium magnet of one of the two correction appliances and the neodymium magnet of the other one of the two correction appliances are capable of repelling or attracting each other.

2. The magnetic orthodontic device as claimed in claim 1, wherein the adhering plate has a recession concaved towards the first connecting portion.

3. The magnetic orthodontic device as claimed in claim 2, wherein the adhering plate has multiple attaching units arranged separately, and each one of the multiple attaching units protrudes away from the first connecting portion.

4. The magnetic orthodontic device as claimed in claim 3, wherein the adhering plate has
multiple first grooves defined in a surface of the recession of the adhering plate and arranged in parallel; and
multiple second grooves defined in the surface of the recession of the adhering plate and arranged in parallel;
the multiple first grooves and the multiple second grooves arranged crosswise.

5. The magnetic orthodontic device as claimed in claim 4, wherein
each one of the multiple first grooves is a dovetail groove;
each one of the multiple second grooves is a dovetail groove.

6. The magnetic orthodontic device as claimed in claim 1, wherein the adhering plate has multiple attaching units arranged separately, and each one of the multiple attaching units protrudes away from the first connecting portion.

7. The magnetic orthodontic device as claimed in claim 1, wherein each one of the two correction appliances has
two hooks respectively disposed at two opposite lateral sides of the linkage portion; and
each one of the two hooks inclines toward the adhering plate.

8. The magnetic orthodontic device as claimed in claim 3, wherein each one of the two correction appliances has
two hooks respectively disposed at two opposite lateral sides of the linkage portion; and
each one of the two hooks inclines toward the adhering plate.

9. The magnetic orthodontic device as claimed in claim 5, wherein each one of the two correction appliances has
two hooks respectively disposed at two opposite lateral sides of the linkage portion; and
each one of the two hooks inclines toward the adhering plate.

10. The magnetic orthodontic device as claimed in claim 6, wherein each one of the two correction appliances has
two hooks respectively disposed at two opposite lateral sides of the linkage portion; and
each one of the two hooks inclines toward the adhering plate.

11. The magnetic orthodontic device as claimed in claim 1, wherein a distance is defined perpendicular to the linkage portion and between a front surface of the adhering plate and a rear end surface of the shell and is greater than or equal to 2 mm and is less than or equal to 8 mm.

12. The magnetic orthodontic device as claimed in claim 3, wherein a distance is defined perpendicular to the linkage portion and between a front surface of the adhering plate and a rear end surface of the shell and is greater than or equal to 2 mm and is less than or equal to 8 mm.

13. The magnetic orthodontic device as claimed in claim 5, wherein a distance is defined perpendicular to the linkage portion and between a front surface of the adhering plate and a rear end surface of the shell and is greater than or equal to 2 mm and is less than or equal to 8 mm.

14. The magnetic orthodontic device as claimed in claim 1, wherein the linkage portion has a length, and the length is greater than or equal to 2 mm and is less than or equal to 10 mm.

15. The magnetic orthodontic device as claimed in claim 3, wherein the linkage portion has a length, and the length is greater than or equal to 2 mm and is less than or equal to 10 mm.

16. The magnetic orthodontic device as claimed in claim 5, wherein the linkage portion has a length, and the length is greater than or equal to 2 mm and is less than or equal to 10 mm.
